(19) United States
(12) Patent Application Publication
(10) Pub. No.: US 2009/0101025 A1
(43) Pub. Date: Apr. 23, 2009

(54) BAKING PAN

(76) Inventor: Jennifer Penson, Studio City, CA (US)

Correspondence Address: DOBRUSIN & THENNISCH PC, 29 W LAWRENCE ST, SUITE 210, PONTIAC, MI, 48342, US

(21) Appl. No.: 12/247,427

(22) Filed: Oct. 8, 2008

Related U.S. Application Data
(60) Provisional application No. 60/981,219, filed on Oct. 19, 2007.

(51) Int. Cl. A21B 3/13

(52) U.S. Cl. 99/426; 493/160

(57) ABSTRACT

The present invention is an improved pan comprising a substrate connected to one end of side walls and the side walls are connected together resulting in a pan that has a hollow cavity for containing food product wherein measurement markings appear on other end of at least two of the side walls. The present invention also includes method of making and method of using the improved pan.

### CLAIM OF BENEFIT OF FILING DATE

This application claims the benefit of U.S. Provisional Application Ser. No. 60/981,219 titled: “Improved Baking Pan” filed on Oct. 19, 2007.

### FIELD OF THE INVENTION

This invention generally relates to an improved baking pan that has a built in measurement template which facilitates even and/or uniform cuts of the finished baked goods.

### BACKGROUND OF THE INVENTION

In a professional kitchen, speed and uniformity are always a priority. With currently available baking pans including cookie sheets, chefs are forced to rely upon templates, separate rulers or measuring tapes or guesswork to cut baked goods into desired sizes. Non-uniform cuts result in unevenly sized baked goods which can hamper their production, presentation and sales.

### SUMMARY OF THE INVENTION

The present invention solves this problem by providing a baking pan with measurement template along its sides so the finished baked goods can be easily cut in any desired even and/or uniform sizes. This would help eliminate wasted or unevenly sized items which aids in the production, presentation and sales of the baked goods. The invention also promotes efficiency for both professional and home uses as it eliminates the need for additional measuring tools for cutting the baked goods into desired portions.

The present invention provides an improved baking pan comprising a substrate connected to one end of side walls and the side walls are connected together resulting in a pan that has a hollow cavity for containing food product wherein measurement markings appear on other end of at least two of the side walls.

The present invention provides a method of making an improved baking pan comprising providing a pan comprising a substrate connected to one end of side walls and the side walls are connected together resulting in a pan that has a hollow cavity for containing food product; and providing measurement markings on other end of at least two of the side walls.

The present invention provides a method of using an improved baking pan comprising providing an improved baking pan comprising a substrate connected to one end of side walls and the side walls are connected together resulting in a pan that has a hollow cavity for containing food product wherein measurement markings appear on other end of at least two of the side walls; placing food product into the pan; baking the food product at desired temperature for a predetermined duration of time; using the measurement markings to cut the food product into desired portions.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of one embodiment of a baking pan in accordance to the principles of the present invention; and

FIG. 2 is a perspective view of one embodiment of a baking pan (also known as a baking sheet) in accordance to the principles of the present invention.

### DETAILED DESCRIPTION OF THE PREFERRED EMBODIMENT

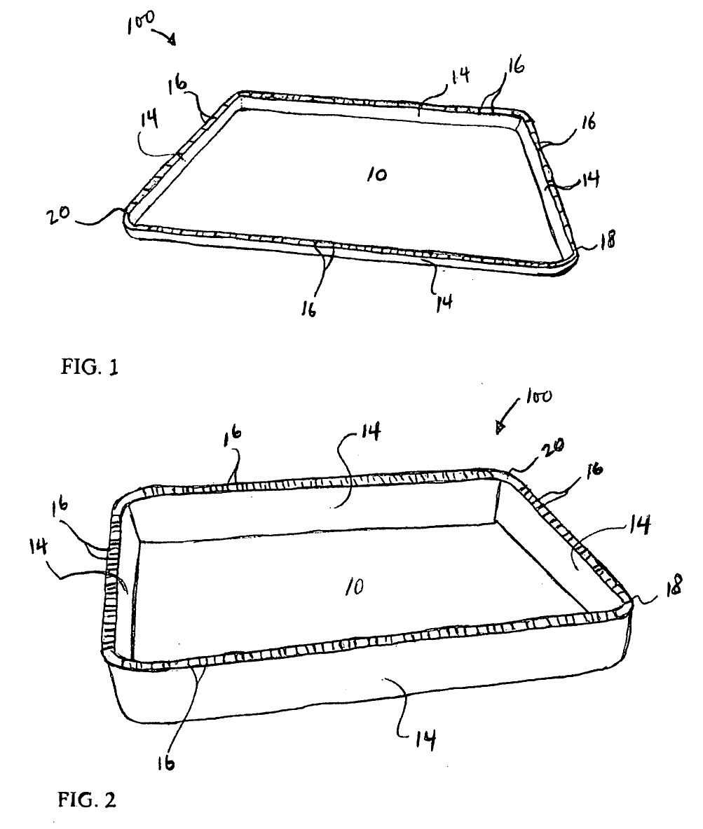

Referring to FIGS. 1-2, the present invention provides an improved baking pan 100 comprising a substrate 10 connected to one (i.e., bottom) end 12 of side walls 14 and the side walls 14 are connected together resulting in a pan that has a hollow cavity for containing food product. Measurement markings 16 resulting in a measurement template appear on other (i.e., top) end 18 of at least two of the side walls 14. The other end 18 of the side walls may optionally include an outer lip 20.

The baking pan 100 can be any shape suitably for providing uniformed portions of baked food product such as rectangle, square, circle or the like. The baked food product can be any desired baked food product (e.g., cake, cookie, baked meat and/or vegetables, etc.). The size of the substrate 10 and the height of the side walls 14 can vary depending on the desired application. For example, the pan 100 can be a baking or cookie sheet that has shorter side walls as shown in FIG. 1 or a deep pan that has taller side walls as shown in FIG. 2.

The measurement markings 16 can be done in increments of (1) inch(es) such as eighth of an inch, quarter of an inch, half of inch, one inch, etc.; (2) a predetermined number of centimeter(s) and/or millimeter(s); (3) any predetermined unit of measurement without uses of inches or centimeters (e.g., markings setting forth one square or slice of baked goods); and a combination thereof.

The preferred embodiments of the present invention have been disclosed. A person of ordinary skill in the art would realize however, that certain modifications would come within the teachings of this invention. Therefore, the following claims should be studied to determine the true scope and content of the invention.

What is claimed is:

1. An improved baking pan comprising a substrate connected to one end of side walls wherein the side walls are connected together resulting in a pan that has a hollow cavity for containing food product and measurement markings appear on other end of at least two of the side walls.

2. The improved baking pan of claim 1 further comprising an outer lip around the other end of the side walls and the measurement markings are provided on the outer lip.

3. The improved baking pan of claim 1 wherein the measurement markings are in increments selected from a group consisting of eighth of an inch, quarter of an inch, half of an inch, one inch, and a combination thereof.

4. The improved baking pan of claim 1 wherein the measurement markings are in increments of a predetermined number of centimeter(s).

5. The improved baking pan of claim 1 wherein the measurement markings are in increments of a predetermined number of millimeter(s).

6. The improved baking pan of claim 1 wherein the pan is a baking sheet.

7. A method of making an improved baking pan comprising:
providing a pan comprising a substrate connected to one end of side walls and the side walls are connected together resulting in a pan that has a hollow cavity for containing food product; and providing measurement markings on other end of at least two of the side walls.

8. The method of claim 7 wherein the pan further includes an outer lip around the other end of the side walls and the measurement markings are provided on the outer lip.

9. The method of claim 7 wherein the measurement markings are in increments selected from a group consisting of eighth of an inch, quarter of an inch, half of an inch, one inch, and a combination thereof.

10. The method of claim 7 wherein the measurement markings are in increments of a predetermined number of centimeter(s).

11. The method of claim 7 wherein the measurement markings are in increments of a predetermined number of millimeter(s).

12. The present invention provides a method of using an improved baking pan comprising:
Providing an improved baking pan comprising a substrate connected to one end of side walls and the side walls are connected together resulting in a pan that has a hollow cavity for containing food product wherein measurement markings appear on other end of at least two of the side walls;
Placing food product into the pan;
Baking the food product at desired temperature for a predetermined duration of time;
Using the measurement markings to cut the food product into desired portions.
